(19) United States
(12) Patent Application Publication
(10) Pub. No.: US 2011/0233142 A1
(43) Pub. Date: Sep. 29, 2011

(54) Water Purification System and Method

(76) Inventors: Lorne D. Grossman, Toronto (CA); Hersh I Forman, Toronto (CA); Andrew Lewis Maxwell, Mississauga (CA); William Alexander Anderson, Waterloo (CA)

(21) Appl. No.: 12/922,385

(22) PCT Filed: Mar. 12, 2009
(86) PCT No.: PCT/CA09/00308

§ 371 Date: Jun. 16, 2011

Related U.S. Application Data
(60) Provisional application No. 61/035,762, filed on Mar. 12, 2008.

(51) Int. Cl. C02F 1/32; B01J 19/08

(52) U.S. Cl. 210/748.1; 210/175; 422/186.3

(57) ABSTRACT

A water purification system and method for removing inorganic, organic and biological species from water. The system and method involve simultaneous treatment of water using mild heat, a photoactive catalyst such as titanium dioxide and UV irradiation.

### CROSS REFERENCE TO RELATED APPLICATION

This application claims priority to and the benefit of U.S. Provisional Patent Application No. 61/035,762 filed Mar. 12, 2008, which is incorporated herein by reference.

### FIELD OF THE INVENTION

The invention pertains to the field of water filtration systems and methods, more particularly, systems and methods for removing contaminants such as bacteria, solvents, trihalomethanes, and heavy metals from water.

### BACKGROUND OF THE INVENTION

Water purification systems abound, both in North America and in the rest of the world. It is often necessary to purify water by removing inorganic, organic, and biological species from the water before it can be used or consumed. Though this purification is especially important in the developing world, in immune compromised patients, and in extreme circumstances, it is generally desirable to have at least relatively pure water for drinking and use.

Methods for removing particulate, chemical, and biological species from water are well known, and include distillation, reverse osmosis filtration, freezing, ionization, photocatalytic treatment, carbon filtration, sand filtration, electrochemical purification, boiling, iodine treatment, chlorine treatment, bromine treatment, oxidization, and submicron filtration.

Industrial water purification systems are used by municipalities and bottling plants to purify water for drinking. Personal and household water purification systems, such as active carbon filtration systems, reverse osmosis filtration systems, electrochemical purification systems, and sand filters, are available and abundant. In emergency scenarios, boiling water, or use of iodine are also very good ways of removing or killing certain contaminants from water. However, each of these purification systems has its own set of disadvantages.

Large throughput, large scale water purification systems are desirable for municipal and bottling plant use; small throughput and small scale water purification systems are equally desirable for military, third world, camping, and boating uses. Medium scale systems are also desirable, for example, for household use. In almost all instances it is desirable to have a system and/or method that modifies the taste of the water as little as possible. In almost all instances it is also desirable to have a system that is as energy efficient as possible. Finally, for many applications, speed of the purification system is an advantage, with systems taking minutes having significant advantage over systems that take hours or days.

One consumer alternative to filtering or purifying water is to purchase bottled water. However, this is an extremely expensive alternative, and, in any event, the purchased, bottled water was itself filtered or purified using an existing method and system.

Water purification systems abound in the art.

U.S. Pat. No. 6,623,603 teaches a water purification system able to remove inorganic and organic contaminants by heating water to convert it to steam, then contacting the steam to a hydrolysis catalyst, such as titanium oxide, at a sufficient temperature to thermo catalytically deactivate the organic and/or biological species, purifying the stream. This system teaches superheating the water, preferably to temperatures well above 100 degrees Celsius, and at the very least requires boiling of the water, often under pressure, —a generally costly, inefficient, and often unsafe process.

Boiling water has long been known to kill microbes (Backer H, Clin. Infect. Diseases (2002) 34:355-64); a standard protocol is to boil the water for a minimum of three minutes (EPA 816-F-99-005).

Photo catalytic purification of water, utilizing a photoactive catalyst (“photocatalyst”) and a light source (such as the sun) is known, and taught, for example, in U.S. Pat. Nos. 4,863,608, 5,227,053, 5,302,356, 5,501,801, 5,516,492, 5,736,055, 5,900,212, 5,919,422, 5,943,950, 6,524,447, 6,57,495, 6,684,648, and 6,932,947. Photocatalysis consists of irradiating a semi-conductor with a high frequency light source, exciting the electrons and leaving the semi-conductor in a photo-excited state. The photo excited semiconductor oxidizes water, forming a hydroxyl radical, an extremely reactive and oxidizing molecule able to break down organic pollutants, often to form carbon dioxide and water. This process has been shown to possess an anti-bacterial and deodorizing effect. Titanium dioxide is a known photo catalyst.

Photo catalysis has been shown to kill bacteria, such as Aeromonas, Campylobacter, Enterotoxigenic Escherichia coli, E. coli O157:H7, Salmonella, Shigella, Vibrio cholera, Yersinia enterocolitia, and others. Photocatalysis has also been shown to kill parasites such as Ancylostoma duodenale, Ascaris lubricoides, Clonorchis sinensis, Diphyllobothrium Iatum, Dracunulus medinensis, Chinococcus granulosus, Fasciola hepatica, Paragonimus westermani, Strongyloids stercoralis, Teania species, Trichuris trichiura, and others. Photocatalysis has been shown to kill protozoa species, such as Acanthamoeba, Vlastocystis hominis, Cryptosporidium species, Cyclospora species, Entamoeba histolytica, Giardia lamblia, Isospora belli, and others. Photocatalysis has also been shown to kill viruses such as hepatitis A, hepatitis E, Norwalk virus, and Polio virus.

Photocatalysis has also been shown to break down CHCl₃, alkanes, alkenes, alkynes, ethers, aldehydes, ketones, alcohols, amine compounds, amide compounds, esters, polychlorinated biphenyls, polycyclic aromatic hydrocarbons, dioxins, furans, phenols, cyanide, as well as many common pesticides and herbicides.

It would be desirable to have an apparatus for the purification of water that provides rapid and/or high purification, preferably at a low per litre cost of processing and/or a low capital cost.

### SUMMARY OF THE INVENTION

According to one aspect of the present invention is a water purification apparatus, comprising: (a) a water reservoir for containing water; (b) an opening in said reservoir for receiving said water; (c) heating means for heating the water contained within said reservoir; (d) irradiation means for irradiating the water contained within said reservoir with ultraviolet light; (e) a photoactive catalyst positioned within said apparatus in a manner such that said photoactive catalyst in contact with at least a portion of the water contained within said reservoir.

In one embodiment of the present invention, the heating means is designed to heat, but not boil, the water.

In a further embodiment of the present invention, the heating means is capable of heating the water to between 40 and 70 degrees Celsius.

In a further embodiment of the present invention, the heating means is designed such that, when activated, it heats the water to between 40 and 60 degrees Celsius.

In a further embodiment of the present invention, the ultraviolet light is of a wavelength of less than 400 nm, for example, between 250 and 270 nm, about 254 nm, or 268 nm.

In a further embodiment of the present invention, the ultraviolet light is of an energy of between 0.1 and 20 Watts, for example, about 7 Watts.

In a further embodiment of the present invention, the water reservoir is capable of holding between 200 ml and 4 litres of water, for example, about 1.5 litres of water.

In a further embodiment of the present invention, the photoactive catalyst is TiO₂.

In a further embodiment of the present invention, the photoactive catalyst is positioned as a coating on an inner surface of said reservoir.

In a further embodiment of the present invention, the water purification apparatus further comprises an electronic or mechanical controller, which controls activation of said heating means and irradiation means.

In one embodiment, the electronic or mechanical controller comprises a timing element, which automatically turns off said heating means and irradiation means at a pre-set time after activation.

In a further embodiment, the water purification apparatus further comprises a status indicator which provides an indication of a level of purification of the water contained therein.

In yet a further embodiment, the water purification apparatus comprises a cooling means for cooling said water, for example, a chilling coil.

In yet a further embodiment, where it is desirable for use in making tea or coffee, for example, the water purification apparatus further comprises a heating means for heating said water to a boil or near boil.

In yet a further embodiment, the electronic or mechanical controller also controls activation of said cooling means, and automatically turns on said cooling means after turning off said heating means and irradiation means.

In yet a further embodiment, the water purification apparatus comprises a circulation means for circulating the water contained within said reservoir.

In yet a further embodiment, the water purification apparatus comprises a filtration device positioned such that, the water travels through said filtration device either when entering or when exiting the water reservoir.

In yet a further embodiment, the water purification apparatus comprises an impeller and a flow tube positioned to encourage the water to flow in close proximity to one or more of the irradiation means and the photoactive catalyst.

In yet a further embodiment, the opening is reversibly sealable.

Another aspect of the present invention is a method for purifying water comprising simultaneously subjecting said water to a heat source, an ultraviolet light, and a photoactive catalyst.

In one embodiment, the heat source is sufficient to heat, but insufficient to boil, the water. For example, the heat source may be sufficient to heat said water to between 40 and 60 degrees Celsius.

In a further embodiment, the ultraviolet light is of a wavelength of below 400 nm, for example, between 250 and 270 nm, or about 254 nm, or about 268 nm.

In a further embodiment, the ultraviolet light is of an energy of between 1 and 20 Watts, for example, an energy of about 7 Watts.

In yet a further embodiment, the method further comprises a filtration step, either before, during, or after simultaneously subjecting said water to said heat, ultraviolet light, and photo active catalyst.

In a further embodiment, the photoactive catalyst is TiO₂.

A further embodiment of the invention is the method wherein the simultaneous subjection of the water to the heat, ultraviolet light, and photoactive catalyst occurs for at least 2 minutes, for example, at least 5 minutes.

In a further embodiment of the invention, the heat and ultraviolet light are controlled by an electronic or mechanical controller.

In a further embodiment of the invention, the electronic or mechanical controller automatically stops the subjection of the water to the heat and ultraviolet light after 2 minutes, or after 5 minutes.

In a further embodiment of the invention, the method comprises a cooling step, occurring after said subjection of the water to the heat and ultraviolet light.

In yet a further embodiment of the invention, the cooling step cools said water to about 4 degrees Celsius.

In yet a further embodiment of the invention, the method comprises a cooling step, occurring after said subjection of the water to the heat and ultraviolet light, wherein said electronic or mechanical controller automatically initiates the cooling step after stopping the heating step.

In yet a further embodiment of the invention, the method comprises mechanically agitating the water.

In yet a further embodiment, the mechanical agitation encourages the water to flow in close proximity to the source of the ultraviolet light, and/or the photoactive catalyst.

### BRIEF DESCRIPTION OF THE DRAWINGS

FIG. 1 shows E. coli viable cell count for heating and UV photo catalytic treatment.

FIG. 2 shows E. coli viable cell count for various heating intensities, when combined with photo catalytic treatment.

FIG. 3 shows one embodiment of the present invention—a kettle having the water purification system described herein.

FIG. 4 shows another embodiment of the present invention—a water cooler having the water purification system described herein.

FIG. 5 shows a further embodiment of the present invention—an in-line purification system having the water purification system described herein.

FIG. 6 shows a further embodiment of the present invention—a “drop-in” retrofit purifier having the water purification system described herein.

### DETAILED DESCRIPTION OF THE INVENTION

The present applicants have surprisingly found that a combination of mild heat and treatment with ultraviolet light, in the presence of a photo catalyst, provides an efficient water purification system that has substantial advantages over other technology solutions. Without wishing to be limited to theory, the present applicants believe that the combination of light activation of the photo catalyst, the germicidal effects of the ultraviolet light, and heat, combine provide a surprising synergistic result. An increased efficiency of UV disinfection is found at slightly elevated, but surprisingly low temperatures of 40 to 60 degrees Celsius. The combination of ultraviolet light, a photo catalyst, and heating provides excellent microbial death, without the need for boiling water. This combination also provides water of excellent taste, which is a common problem with boiling water, which even if the microbes have been removed, typically has an undesirably flat taste. The present applicants believe that the present method is useful in purifying water by killing bacteria, such as Aeromonas, Campylobacter, Enterotoxigenic Escherichia coli, E. coli O157:H7, Salmonella, Shigella, Vibrio cholera, Yersinia enterocolitia, parasites such as Ancylostoma duodenale, Ascaris lubricoides, Clonorchis sinensis, Diphyllobothrium Tatum, Dracunulus medinensis, Chinococcus granulosus, Fasciola hepatica, Paragonimus westermani, Strongyloids stercoralis, Teania species, Trichuris trichiura, protozoa such as Acanthamoeba, Vlastocystis hominis, Cryptosporidium species, Cyclospora species, Entamoeba histolytica, Giardia lamblia, Isospora belli, viruses such as hepatitis A, hepatitis E, Norwalk virus, and Polio virus, as exemplified by the killing of E. coli, as shown below.

The present method is also useful in purifying water from undesirable impurities such as CHCl₃, alkanes, alkenes, alkynes, ethers, aldehydes, ketones, alcohols, amine compounds, amide compounds, esters, polychlorinated biphenyls, polycyclic aromatic hydrocarbons, dioxins, furans, phenols, cyanide, as well as many common pesticides and herbicides.

### EXAMPLES

### Example 1

### Synergistic effects of heating, UV treatment, and exposure to a photo catalyst on E. coli

The antimicrobial effect of the combination of mild heat, UV treatment, and the presence of a photo catalyst is determined.

For each group, a beaker containing approximately 100 ml of contaminated water (water containing approximately 10⁷ cells/ml of E. coli bacteria) is subjected to treatment with heat and/or UV treatment in the presence of a photo catalyst.

Groups that are heated are subjected to heat to approximately 40 degrees Centigrade, utilizing an external heat source (a heating element).

UV treatment consists of exposure to a lit 9W PL-SS type compact mercury discharge bulb, having an output primarily at 254 nm.

The UV treated groups contain a tablet of titanium dioxide, approximately 3″×2″×½″, in the beaker, in direct contact with the water. The titanium dioxide contains a significant amount of the anatase crystalline form.

Treatment groups are as follows: Control (no UV treatment, no heating); Heat (heating at approximately 40° C., no UV treatment); UV (no heat, exposure to a lit 9W PL-SS type compact mercury discharge bulb, having an output primarily at 254 nm, in the presence of photo catalyst); UV+Heat (40 C) (heating at approximately 40° C., exposure to a lit 9W PL-SS type compact mercury discharge bulb, having an output primarily at 254 nm, in the presence of photo catalyst); and UV+Heat (50 C) (heating at approximately 40° C., exposure to a lit 9W PL-SS type compact mercury discharge bulb, having an output primarily at 254 nm, in the presence of photo catalyst).

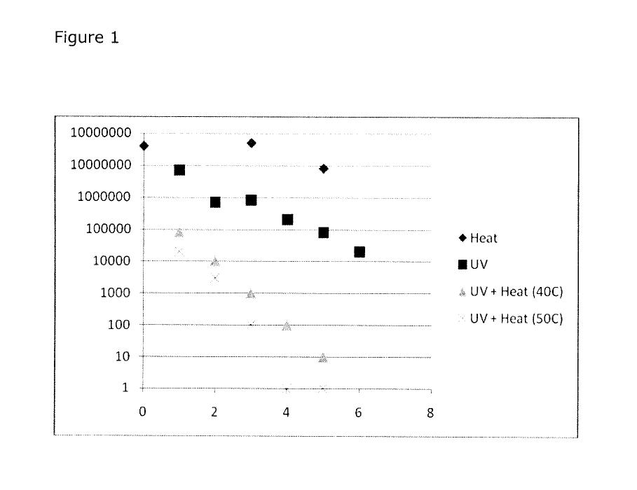

E. coli viable cell count is performed at one minute intervals for the five groups, with results tabulated in FIG. 1 (E. coli viable cell count for the control group is not shown, but is “off the chart” i.e. over 10⁷). Viable E. Coli cell count is shown on the vertical axis, with time of treatment, in minutes, shown on the horizontal axis. As can be seen, the combination of mild heating and UV photo catalytic treatment provides dramatic and synergistic antimicrobial effect, at both heating temperatures.

### Example 2

### Temperature Sensitivity Study

The effect of heating to different temperatures while treating the sample with UV is determined.

For each group, a beaker containing approximately 100 ml of contaminated water (water containing approximately 10⁷ cells/ml of E. coli) is subjected to treatment with heat or heat+UV treatment in the presence of a photo catalyst, for a total of 3 minutes. UV treatment consists of exposure to a lit 9W PL-SS type compact mercury discharge bulb, having an output primarily at 254 nm. The photo catalyst used is a tablet of titanium dioxide, approximately 3″×2″×½″, placed inside the beaker, and in direct contact with the contaminated water. The titanium dioxide contains a significant amount of the anatase crystalline form.

Various temperatures of heat are tested.

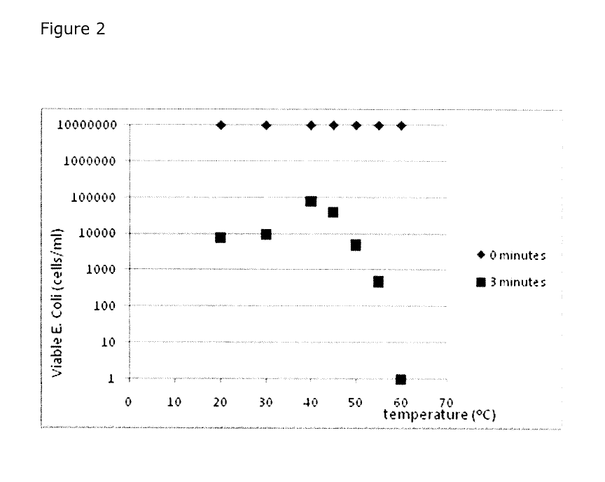

E. coli viable cell count is determined after 3 minutes of treatment, for various different temperature groups. The results are tabulated in FIG. 2.

At temperatures of over 40° C., there is an increased efficiency of UV disinfection; this efficiency increases with temperature, to a maximal efficiency at or over about 60° C. The effect of temperature on UV disinfection is not significant at temperatures under about 40° C.

### Example 3

### Kettle

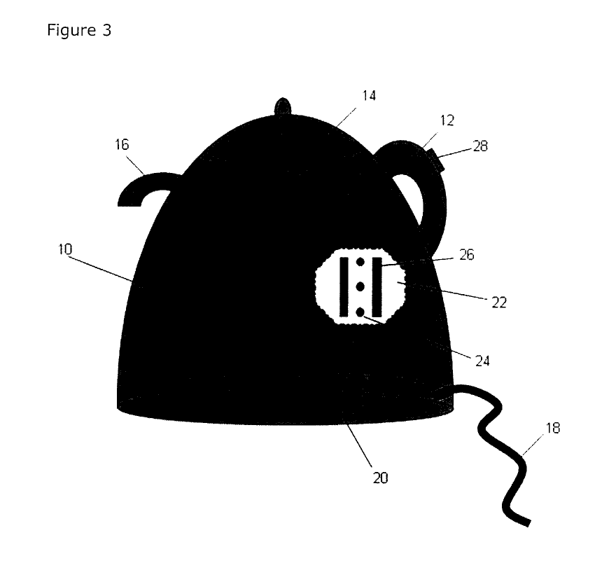

One embodiment of the present invention is illustrated in FIG. 3. The embodiment resembles a traditional kettle. A reservoir 10, with a handle 12, lid 14, and spout 16 can be filled with water by removing lid 14. Optionally, lid 14 may be on a hinge, so that it can be displaced for the filling of the reservoir 10 with water. Handle 12 can be used to displace the container 10. Once the reservoir 10 is filled with water, it is plugged into a standard wall socket using power cable 18. Power cable 18 provides power to heating element 20, as well as to a UV light source 24, contained on the inside of the reservoir 10, and seen in FIG. 1 through a “cut out” 22 in the wall of the container, which is shown for illustration purposes only. The inside wall of the reservoir 10 is coated or plated with photoactive catalyst 26.

In the illustrated embodiment, the photoactive catalyst 26 is titanium dioxide, and is coated on a portion of the inside surface of the reservoir 10 in a “stripe” pattern, in alternating strips adjacent to the UV light source. However, different configurations are possible, such as plating the entire inner surface of the reservoir 10 with the photoactive catalyst 26, or fastening a plate comprising or made from photoactive catalyst (such as a solid plate of titanium dioxide) to the inner surface of the reservoir 10.

In the illustrated embodiment, the UV light source 24 is an LED light. However, different sources of UV light can be used, for example, a fluorescent strip or a halogen bulb.

A power switch 28, located on the handle 12 activates the heating element 20 and UV light source 24. Optionally, the heating element 20 and UV light source 24 are connected to an electronic control system (not shown), which is activated by the power switch 28. When activated by the power switch 28, the electronic control system, in turn, activates the heating element 20 and the UV light source 24. The electronic control system is able to determine when the water in the reservoir 10 has attained a desired temperature, using conventional means such as a heat sensor (not shown), and is able to control the heating element in a manner to keep the water at said desired temperature for a desired period of time.

In the presently illustrated embodiment, once the power switch 28 is activated by the user, the electronic control system activates the heating element such that the water in the kettle is heated to between 45 and 55 degrees Celsius. The electronic control system then maintains the heat, through activation of the heating element 20, for a minimum of 3 minutes. The electronic control system then automatically deactivates the heating element 20.

Not shown in the illustrated embodiment, but optionally present, is a mechanical device for guiding the flow of water close to the UV source and the photo catalyst. For example, the kettle may contain a stir bar, or a pump and a series of channels, to ensure maximal contact between the water contained therein and the photo catalyst and energy from the UV source.

Simultaneous with said heating, the electronic control system also activates the UV light source 24, from the time the heating element 20 is activated, to the time the heating element 20 is deactivated. In alternative embodiments, the UV light source 24 can be activated only from the time the water reaches the desired temperature, for a specific defined time, for example, 2 minutes. In one embodiment of the invention (not shown), the kettle also comprises an electronic indicator, for example, an LED light, to indicate the stage of the process and the condition of the water. For example, the electronic indicator can show a red light when water is added, an amber light when the kettle is operating, and a green light when the water in the kettle has been treated for the desired period of time.

In one embodiment of the invention (not shown), the reservoir 10 also comprises a cooling element (not shown). The cooling element is activated by the electronic control system to cool the water to a desired temperature, for example, between 4 and 10 degrees Celsius, shortly after the heating element is deactivated. In this manner, the water purification system is able to provide cold, clean, purified water. The cooling element may be on a timer or otherwise controlled by the electronic control system.

Further, the container 10 may contain an agitation mechanism (not shown), such as a rotating blade, for agitating the water contained within it. The agitation mechanism may be controlled by the electronic control system for agitation during heating and/or UV exposure, to increase water contact with photoactive catalyst 26.

The container 10 may also contain a filter, such as an activated carbon filter or a paper filter, for removing unwanted elements from the water. For example, the filter can be removably affixed directly under the lid 14, for filtration when water is poured into the reservoir 10, or can be removably affixed to the spout 16, for filtration when the purified water is removed from the reservoir 10.

### Example 4

### Water Cooler

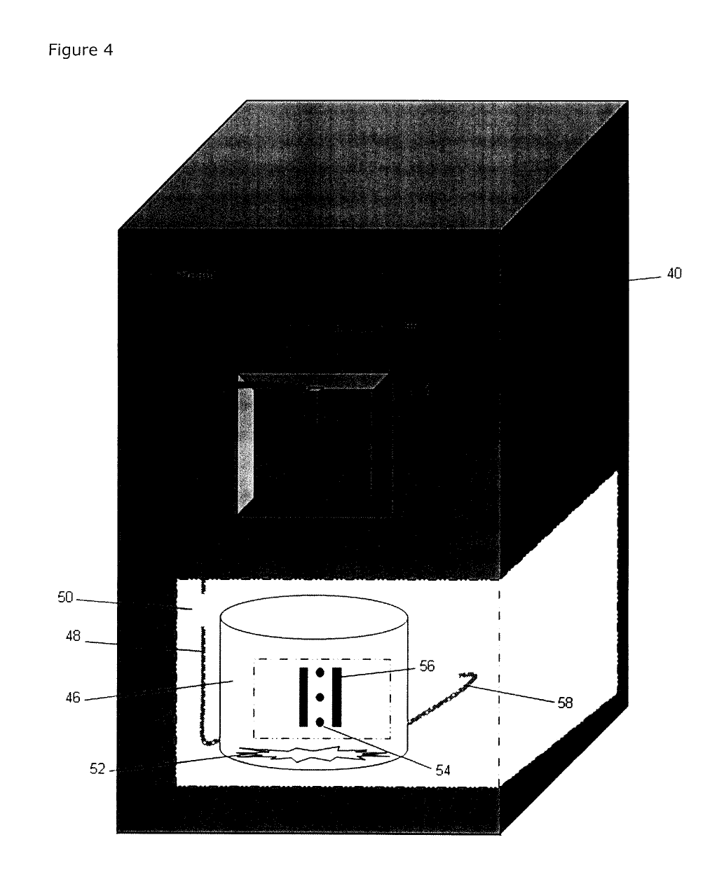

This example illustrates an embodiment of the invention, as applied to a “water cooler” or other water dispensing device, as exemplified in FIG. 4. A water cooler 40 is shown, having a dispensing spout 42 which is activated by a dispensing switch 44. A user of the device would place a water glass or bottle under the dispensing spout 42, and press the dispensing switch 44 to dispense water from the water cooler 40 into their glass. Many different forms of dispensing switches 44 can be envisaged by a person skilled in the art.

The dispensing spout 42 is connected to a water reservoir 46 by a water dispensing tube 48. When the dispensing switch 44 is depressed or otherwise activated by the user, this activates water pump 50 which displaces water from the reservoir 46 through water dispensing tube 48 and out of dispensing spout 42. Optionally, the water pump 50 may not be necessary, for example, in the case of a gravity-fed dispensation. In this case, typically, reservoir 46 would be located above dispensing spout 42, and dispensing switch 44 would simply open a valve or other tube opening mechanism allowing water to displace from reservoir 46 through water dispensing tube 48 and out of dispensing spout 42.

Reservoir 46 is designed to hold water, and comprises a heating element 52, a UV light source 54, and a photoactive catalyst 56. The reservoir 46 is similar in function and elements to the reservoir 10 as described in Example 3. Water enters reservoir 10 through water intake tube 58, which is either connected to a water source, such as a residential water line, or to a filling spout on the water cooler 40 for manual user addition of water. The water is then subjected to heating by heating element 52, UV light by UV light source 54, and contact with photoactive catalyst 56. Optionally, the water is then cooled with a cooler (not shown) located within the reservoir 10.

Entry of water into the reservoir 46 is controlled electronically, when a sensor (not shown) determines that the reservoir 46 requires filling. Optionally, entry of water into reservoir 46 can trigger activation of the water purification process, i.e. the activation of the heating element 52, UV light source 54, and optionally a water agitator (not shown).

In an alternative embodiment, the water purification can occur in one reservoir 46 as described, then automatically transferred (by gravity, syphon or pump) to a second “holding” reservoir, connected to dispensing spout 42. In this manner, the water is purified, then transferred to a second reservoir, where it can be held indefinitely, and, if desired, cooled to a drinking temperature. The second “holding” reservoir can be smaller or larger than the reservoir 46, and can be used as a “buffer” area, so that the water cooler always has water to dispense. In the case where a holding reservoir is used, the activation of the transfer of water from water intake tube 58 to reservoir 46 can automatically occur when the holding reservoir approaches empty, with water automatically transferring from reservoir 46 to the holding reservoir (not shown) after purification through activation of heating element 52, UV light source 54, and optionally a water agitator (not shown).

As in Example 3, the reservoir 46 can be placed in line with a water filter, such as a carbon filter or a paper filter, which can be removably affixed within, before, or after water intake tube 58, or within, before or after water dispensing tube 48.

### Example 5

### In-Line Purification System

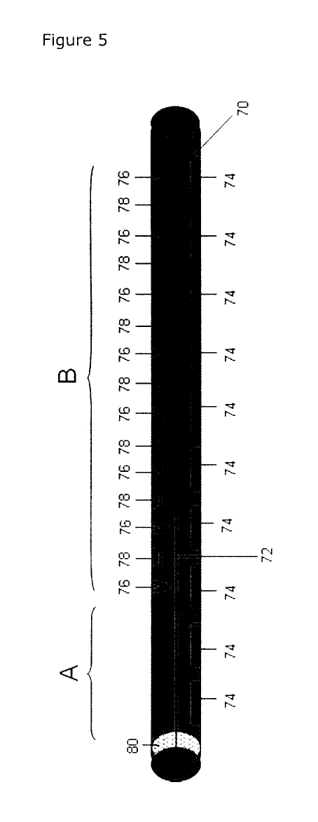

A further embodiment of the present invention is an in-line water purification system. The system can be retro-fitted to a standard water line, such as a residential, ¾ inch water main, or can be scaled into a larger system, such as a municipal water treatment plant. An in-line water purification system is shown in FIG. 5.

Water travels through pipe 70 in direction 72. The pipe is fitted with one or more heating elements 74 such that, as the water travels through the pipe 70, it is heated to the desired temperature, for example, between 45 and 55 degrees Celsius. The power and number of heating elements 74 are designed such that the water is heated to the desired temperature in region A and maintained at that temperature in region B of the pipe 70. Of course, the power of the heating elements 74 can be either fixed and designed for a specific flow rate and temperature of water coming into the pipe, or can be variable and electronically controlled based on the temperature and flow rate of the water coming into the pipe 70.

Pipe 70 also contains, in region B, at least one UV light source 76 and at least one photoactive catalyst region 78. Region B is designed to be of a length such that the water flowing through region B is subjected to heat, UV treatment, and photoactive catalyst for a desired amount of time. In cases of variable flow rates, region B can be “in excess”. In one embodiment, a flow rate sensor (not shown) is built into the pipe, and the length of region B is modified by activating or deactivating individual UV light source and heating elements. For example where flow rate is determined to be 3 metres per minute, and a 3 minute treatment is desired, the heating elements 74 and UV light source 76 in the second half of region B can be deactivated, to save energy costs while obtaining the desired water purification treatment (3 minutes of water purification). In complex systems, this can be done automatically and by computer control.

In simpler systems, Region A may not exist, with region B being long enough to both heat up the water to the desired temperature, and maintain it there for a length of time sufficient for UV and photocatalytic treatment.

Agitation of the water going through the pipe can be increased to increase contact between the water and the photoactive catalyst 56. This can be done through the use of agitators, such as rotating vanes or blades, or can take advantage of the existing motion of the water, by using ducts, paths, or vortexing elements. Alternatively or in addition, the agitation can utilize the thermal currents created by heating the water to direct the heated water in front of the UV and photo catalyst.

A filtration element 80 can be placed in line with the pipe, either before, during or after the heating elements 74. The filtration element may be an activated carbon or a paper filter, for example, and may be user replaceable.

### Example 6

### “Drop In” Retrofit Purifier

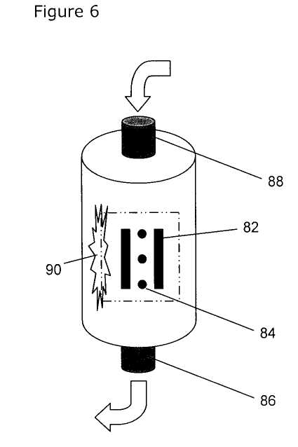

A further embodiment of the present invention is a “drop in” retrofit purifier (FIG. 6). In this embodiment, all of the elements of the invention are placed within a self-contained apparatus that can be placed in a vat or reservoir, for purifying the water contained within said reservoir. The retrofit purifier comprises a heating element 90, a UV light source 84, and a photoactive catalyst 82. The retrofit purifier is similar in function and elements to the reservoir 10 as described in Example 3. Water is actively pumped into the retrofit purifier through water intake 88, by use of a pump located within the retrofit purifier, or within the water intake 88 (not shown). The water is then subjected to heating by heating element 90, UV light by UV light source 84, and contact with photoactive catalyst 82. The water then leaves the retrofit purifier through water outtake 86.

1. A water purification apparatus, comprising:
(a) a water reservoir for containing water;
(b) an opening in said reservoir for receiving said water;
(c) heating means for heating the water contained within said reservoir;
(d) irradiation means for irradiating the water contained within said reservoir with ultraviolet light;
(e) a photoactive catalyst positioned within said apparatus in a manner such that said photoactive catalyst in contact with at least a portion of the water contained within said reservoir.

2. (canceled)

3. (canceled)

4. The water purification apparatus of claim 1, wherein the heating means is designed such that, when activated, it heats the water to between 40 and 60 degrees Celsius.

5. The water purification apparatus of claim 1 wherein the ultraviolet light is of a wavelength of less than 400 nm.

6. (canceled)

7. The water purification apparatus of claim 5 wherein the ultraviolet light is of a wavelength of about 254 nm.

8. The water purification apparatus of claim 1 wherein the ultraviolet light is of an energy of between 0.1 and 20 Watts.

9. (canceled)

10. (canceled)

11. (canceled)

12. The water purification apparatus of claim 1 wherein the photoactive catalyst is TiO₂.

13. The water purification apparatus of claim 1 wherein the photoactive catalyst is positioned as a coating on an inner surface of said reservoir.

14. (canceled)

15. (canceled)

16. (canceled)

17. The water purification apparatus of claim 1 further comprising a cooling means for cooling said water.

18. (canceled)

19. (canceled)

20. (canceled)

21. (canceled)

22. The water purification apparatus of claim 1 further comprising a circulation means for circulating the water contained within said reservoir.

23. The water purification apparatus of claim 1 further comprising a filtration device positioned such that, the water travels through said filtration device either when entering or when exiting the water reservoir.

24. The water purification apparatus of claim 1 further comprising an impeller and/or a flow tube positioned to encourage the water to flow in close proximity to one or more of the irradiation means and the photoactive catalyst.

25. (canceled)

26. A method for purifying water comprising simultaneously subjecting said water to a heat source, an ultraviolet light, and a photoactive catalyst.

27. The method of claim 26 wherein said heat source is sufficient to heat, but insufficient to boil, the water.

28. (canceled)

29. (canceled)

30. (canceled)

31. The method of claim 27 wherein the ultraviolet light is of a wavelength of about 254 nm.

32. The method of claim 27 wherein the ultraviolet light is of a wavelength of about 268 nm.

33. The method of claim 26 wherein the ultraviolet light is of an energy of between 0.1 and 20 Watts.

34. (canceled)

35. The method of claim 26 further comprising a filtration step, either before, during, or after simultaneously subjecting said water to said heat, ultraviolet light, and photoactive catalyst.

36. The method of claim 26 wherein the photoactive catalyst is TiO₂.

37. The method of claim 26 wherein the simultaneous subjection of the water to the heat, ultraviolet light, and photoactive catalyst occurs for at least 2 minutes.

38. (canceled)

39. (canceled)

40. The method of claim 37 wherein the heat and ultraviolet light are controlled by an electronic or mechanical controller, and wherein the electronic or mechanical controller automatically stops the subjection of the water to the heat and ultraviolet light after 2 minutes.

41. (canceled)

42. (canceled)

43. (canceled)

44. (canceled)

45. (canceled)

46. (canceled)
